(19) United States
(12) Patent Application Publication
(10) Pub. No.: US 2015/0052048 A1
(43) Pub. Date: Feb. 19, 2015

(54) MERCHANDISE SALES SYSTEM

(71) Applicant: BIGLOBE INC., Tokyo (JP)

(72) Inventors: Tomoyuki Kagawa, Tokyo (JP); Fumitake Yoshikawa, Tokyo (JP)

(73) Assignee: BIGLOBE INC., Tokyo (JP)

(21) Appl. No.: 14/388,167

(22) PCT Filed: Mar. 26, 2013
(86) PCT No.: PCT/JP2013/058849

§ 371 Date: Sep. 25, 2014

(30) Foreign Application Priority Data
Mar. 30, 2012 (JP) 2012-081124

(51) Int. Cl. G06Q 30/04

(52) U.S. Cl. CPC G06Q 30/04
USPC 705/40

(57) ABSTRACT

A merchandise sales system that simplifies the purchase action of the customer is provided. This merchandise sales system constructs a merchandise sales system provided with: a portable terminal capable of reading a two-dimensional code; a member information management server that manages preregistered information related to a member; an authentication server that converts information related to billing referred to when a commodity is purchased (billing information) into a two-dimensional code; and a display device that displays the two-dimensional code. The portable terminal reads the displayed two-dimensional code and obtains billing code information included in the two-dimensional code, and when a commodity two-dimensional code including information on a commodity to be purchased is read, generates purchase information in which a commodity ID indicated by the commodity two-dimensional code and the billing code information are associated with each other and supplies it to the member information management server. When the purchase information is received through a network, the member information management server confirms purchase of the commodity corresponding to the commodity ID included in the purchase information.

### TECHNICAL FIELD

The present invention relates to a merchandise sales system, and more particularly, relates to a merchandise sales system using a two-dimensional code such as a two-dimensional bar code or a QR code (trademark).

### BACKGROUND ART

A technology is known where when a commodity advertisement is placed on TV, in a magazine, on a signboard or the like, a two-dimensional code incorporating the URL of the commodity introduction page is shown in the advertisement in order that the user motivated to purchase moves on to a purchase action immediately. In a merchandise sales system using such a technology, the user can access the commodity introduction page with a portable telephone or the like according to the URL incorporated in the two-dimensional code. For this reason, the commodity to be purchased can be purchased without any cumbersome work such as inputting the URL being performed.

Generally, in various scenes of a merchandise sales system using a network, user authentication is performed when a commodity is purchased. For the user authentication, for example, a combination of an ID and a password assigned to each user registered as a member is previously recorded on a database device. When access is made by any of the user computers, transmission of the ID and the password of the operator is required of the user computer. Whether the combination of the ID and the password transmitted by the user computer in response thereto has been registered in the database device or not is checked, and when it has been registered, the user is authenticated as a member.

A technology is known that provides an authentication method enabling authentication without the users being forced to store complicated IDs and passwords (for example, see Patent Document 1). According to the technology described in Patent Document 1, individual identification information of a portable telephone possessed by each member is stored in a portable telephone authentication DB so as to be associated with the ID of each. Moreover, when a service use request is made from a user PC, a service host program generates a unique identifier, stores the identifier in a memory, converts the URL of an authentication host computer including the identifier as a parameter into a QR code (trademark), and transmits it to the user PC. When the requester member performs an operation of decoding this QR code (trademark) into a URL and accessing the URL, an HTTP request message that includes the URL including the identifier and the individual identification information of the user portable telephone is transmitted to the authentication host computer, the individual identification information in the message is authenticated based on the portable telephone authentication DB and notification is provided to the service host computer.

### PRIOR ART REFERENCE

### Patent Document

Patent Document 1: JP 2008-146363 A

### SUMMARY OF INVENTION

In the merchandise sales system using a network, for example, even if the customer (user) is guided to the commodity introduction page, in order that a purchase is completed, it is necessary to have the customer further perform purchase actions. Normally, purchase is abandoned in many cases since not only user authentication of the customer but also registration of billing information and the like are necessarily performed as main purchase actions and this requires time and trouble.

To solve the above-mentioned problem, a merchandise sales system is constructed that is provided with: a portable terminal capable of reading a two-dimensional code; a member information management server that manages preregistered information related to a member; an authentication server that converts information related to billing referred to when a commodity is purchased (billing information) into a two-dimensional code; and a display device that displays the two-dimensional code. The portable terminal reads the displayed two-dimensional code and obtains billing code information included in the two-dimensional code, and when a commodity two-dimensional code including information on a commodity to be purchased is read, generates purchase information in which a commodity ID indicated by the commodity two-dimensional code and the billing code information are associated with each other and supplies it to the member information management server. When the purchase information is received through a network, the member information management server confirms purchase of the commodity corresponding to the commodity ID included in the purchase information.

Briefly explaining an advantage obtained by a representative one of the inventions disclosed in the present application, an advantage is obtained that it is possible to purchase a commodity anytime and anywhere by (previously) holding in a mobile terminal the billing information necessary for commodity purchase in advance.

### BRIEF DESCRIPTION OF THE DRAWINGS

FIG. 1 is a block diagram illustrating the structure of a merchandise sales system 1 of the present embodiment.

FIG. 2A is a view illustrating the structure of billing code information 21.

FIG. 2B is a view illustrating the structure of the billing code information 21.

FIG. 3 is a view illustrating the structure of purchase information 22.

FIG. 4 is a view illustrating the structure of a member information management table 23.

FIG. 5 is a view illustrating the structure of a purchase information management table 24.

FIG. 6A is a view illustrating the structure of billing information.

FIG. 6B is a view illustrating the structure of a billing information table.

FIG. 7A is a view illustrating the structure of a commodity code information table 31.

FIG. 7B is a view illustrating the structure of commodity code information.

FIG. 8 is a flowchart illustrating the operation of the commodity purchase in the merchandise sales system 1 of the present embodiment.

FIG. 9 is a flowchart illustrating the operation of a member information management server 3 having received the purchase information 22 supplied from a portable terminal 2.

FIG. 10 is a sequence diagram illustrating the operation of generating the billing code information 21 of the present embodiment.

FIG. 11 is a sequence diagram illustrating the operation of registering member information 25 in the member information management table 23.

FIG. 12 is a sequence diagram illustrating the operation of generating a two-dimensional code of the commodity to be sold.

FIG. 13 is a flowchart illustrating the operation of the commodity purchase in the merchandise sales system 1 of a second embodiment.

FIG. 14 is a flowchart illustrating the operation of the commodity purchase in the merchandise sales system 1 of a third embodiment.

FIG. 15 is a view illustrating the structure of the member information management table 23 of a fourth embodiment.

FIG. 16 is a sequence diagram illustrating the operation of the fourth embodiment.

### DESCRIPTION OF THE EMBODIMENTS

### First Embodiment

Hereinafter, embodiments of the present invention will be described based on the drawings. In the drawings for explaining the embodiments, the same members are denoted by the same reference numerals and signs in principle, and repetitive descriptions thereof are omitted.

### [Merchandise Sales System]

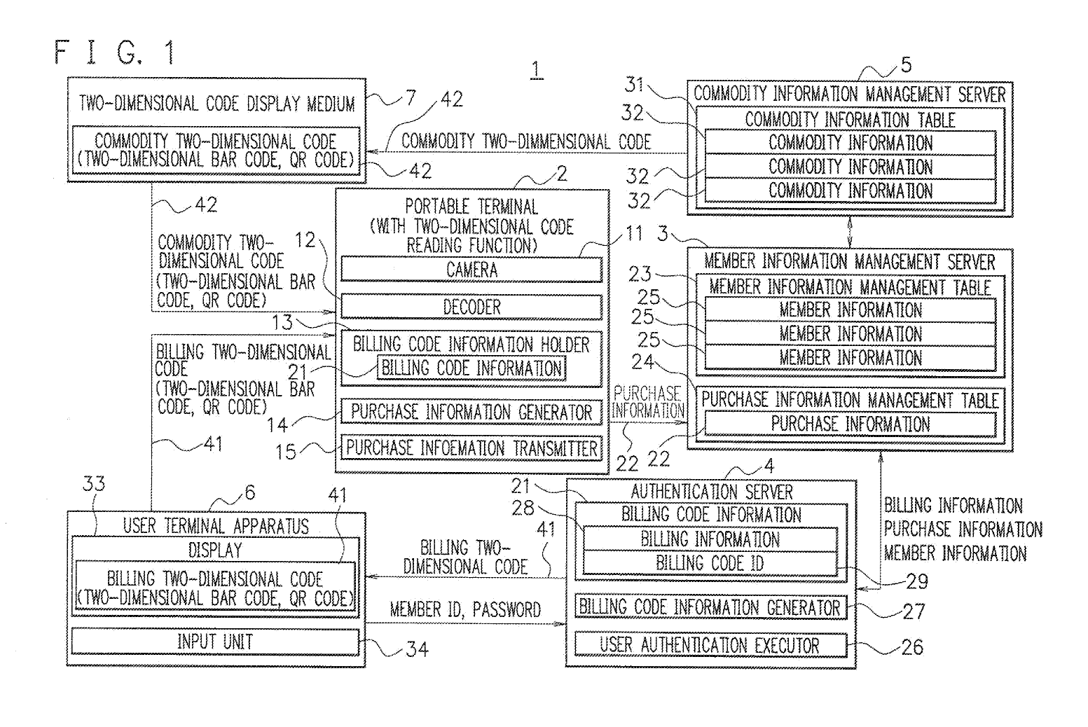

FIG. 1 is a block diagram illustrating the structure of a merchandise sales system 1 of the present embodiment.

The merchandise sales system 1 is provided with a portable terminal 2, a member information management server 3, an authentication server 4, a commodity information management server 5, a user terminal apparatus 6 and a two-dimensional code display medium 7.

The portable terminal 2 combines billing code information and commodity code information to create purchase information. The member information management server 3 manages member information such as information related to user authentication and the payment method. The authentication server 4 obtains the member information when the user is authenticated as a member, creates billing information and the billing code information managing the code of the billing information, and converts it into a two-dimensional code. The commodity information management server 5 manages commodity information, generates a commodity ID to identify the commodity, converts it into a two-dimensional code, and takes the procedure of shipping the commodity. The user terminal apparatus 6 transmits information related to authentication to the authentication server. The two-dimensional code display medium 7 displays the two-dimensional code.

In the following embodiments, for easy understanding of the invention of the present application, a case where the member information management server 3, the authentication server 4 and the commodity information management server 5 are independent devices is shown as an example. This structure does not limit the structure of each server of the present embodiment. For example, a structure may be adopted such that the member information management server 3 and the authentication server 4 are provided as computer programs and provide the server functions in the same device. The computer programs according to the present invention may be stored in a storage device and a storage medium. Moreover, part of a server function may be performed in a state of being included in another server.

The portable terminal 2 is a portable communication terminal provided with a two-dimensional code reading function. The portable terminal 2 is provided with a camera 11, a decoder 12, a billing code information holder 13, a purchase information generator 14 and a purchase information transmitter 15.

The portable terminal 2 is provided with the function of creating purchase information when the billing code information and the commodity code information are obtained and transmitting it to a member management server. The user photographs the two-dimensional code by using the camera 11 of the portable terminal 2. The decoder 12 reads the information contained in the photographed two-dimensional code. The billing code information holder 13 stores billing code information 21. The purchase information generator 14 generates purchase information 22 including information on the commodity to be purchased and the billing code information 21. The purchase information transmitter 15 transmits the purchase information 22 to the member information management server 3. Moreover, a function may be provided of requesting the commodity information management server to transmit the commodity information associated with the commodity ID, obtaining the commodity information and displaying it.

The purchase information generator 14 is a program for matching the commodity information and the billing information with each other to create the purchase information, and is preferably incorporated in the portable terminal 2 in advance. A structure may be adopted in which the purchase information generator 14 has a form like an application and the incorporation of the purchase information generator 14 is performed by providing an instruction to download and install the application by a user operation. The purchase information generator 14 is stored in a storage area of the portable terminal 2, and regarding the operation thereof, when there is a user instruction, the operation is performed by using a controller of the portable terminal 2.

The member information management server 3 holds information on the members when the merchandise sales system 1 adopts a membership system. The member information management server 3 is provided with a member information management table 23 and a purchaser information management table 24. The member information management table 23 holds a plurality of pieces of member information 25. The purchase information management table 24 holds the received purchase information 22. Specifically, the address, name, payment method such as a credit card number and upper limit of billing (maximum amount, expiration date) of each member are managed by the member information management server 3. Moreover, the member information management server 3 is provided with a billing information table. The billing information table holds a plurality of pieces of billing information 28 created by the authentication server.

The authentication server 4 performs user authentication and generation of the billing code information 21. The authentication server 4 is provided with a user authentication executor 26 and a billing code information generator 27. The user authentication executor 26 receives the member ID and the password, and executes user authentication. The billing code information generator 27 generates the billing code information 21 of the member the authentication of which has been completed. The billing code information 21 includes at least a billing code ID 29 and the upper limit of billing. The billing code information generator 27 generates a two-dimensional code from the billing code information. In other words, an inquiry about the authentication information (the member ID and the password) inputted by the user is made to the member information management server 3. When the inquiry is successful, the upper limit of billing is obtained, the member ID, the billing information including the upper limit of billing and the billing code ID to identify the billing information are created, the billing code information including the billing code ID and the upper limit of billing is created, and a billing two-dimensional code is generated from the billing code information. The created billing information is transmitted to the member information management server 3, and managed with the billing information table. The payment method corresponding to the member ID may be obtained from the member information management server 3 and also included in the billing information. It is preferable that the two-dimensional bar code of the generated billing code information be managed at least one of the authentication server 4 and the member information management server 3.

The commodity information management server 5 manages the information on the commodities to be sold. The commodity information management server 5 reads at least the commodity ID (for example, the URL of the page introducing information on the commodity) from commodity information 32, generates the commodity code information including at least the commodity ID, and generates a commodity two-dimensional code from the commodity code information. This commodity code information may include other pieces of information related to the commodity such as the price. This commodity two-dimensional code is displayed on EC sites, electronic advertisements, TV programs, street advertisements and the like. Moreover, the commodity information management server 5 is provided with the function of managing the commodity information and the commodity code information and when there is an inquiry, transmitting the commodity information associated with the commodity ID to the portable terminal 2.

The user terminal apparatus 6 is a terminal apparatus that can be used by the user. The user terminal apparatus 6 is provided with a display 33 and an input unit 34. The display 33 displays the billing two-dimensional code 41 supplied from the authentication server 4. On the input unit 34, the member ID and the password are inputted when user authentication is performed.

The two-dimensional code display medium 7 is a medium capable of displaying the commodity two-dimensional code 42. For example, a television screen, a storefront monitor and a magazine article correspond to the two-dimensional code display medium 7 of the present embodiment.

### [Billing Code Information]

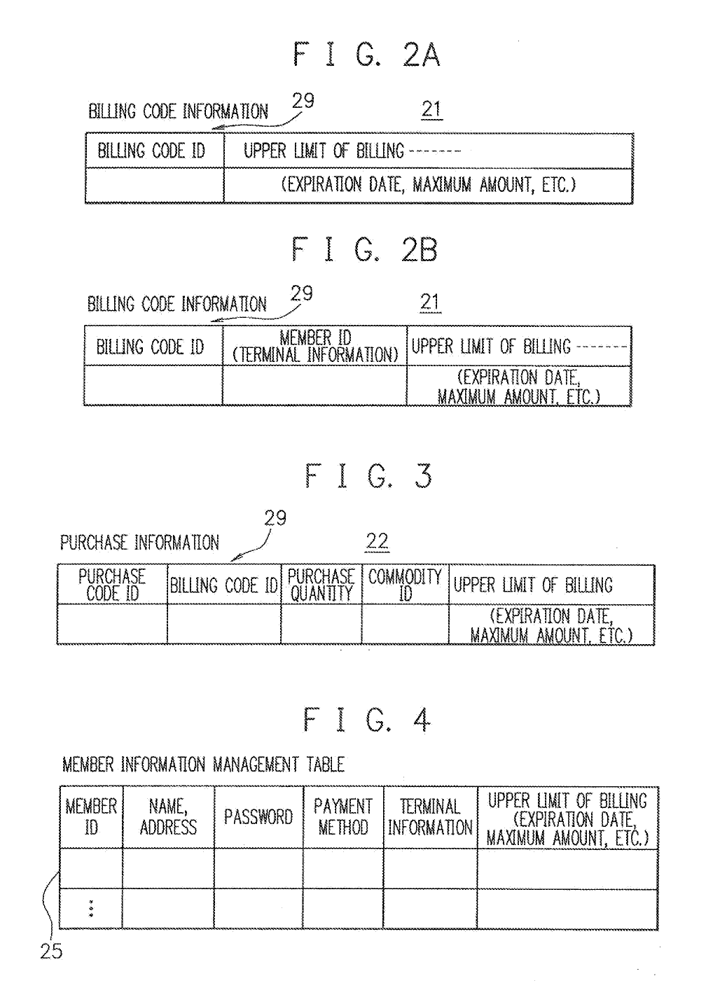

FIG. 2A and FIG. 2B are views illustrating the structure of the billing code information 21. As shown in FIG. 2A, the billing code information 21 includes the billing code ID 29 and the upper limit of billing. Moreover, as shown in FIG. 2B, the billing code information 21 may additionally include the date and time of creation of the member ID and the billing information. The billing code ID 29 is an ID for identifying the billing information. The billing code ID 29 may be created from the member ID and the date and time of creation of the billing information or may be created by using characters, numerals and symbols as long as it is a unique ID by which the billing information can be identified. The upper limit of billing includes information related to at least one of the number of times of use, the expiration date, the maximum amount and the like of the billing information.

### [Purchase Information]

FIG. 3 is a view illustrating the structure of the purchase information 22. The purchase information 22 of the present embodiment includes information on the purchased commodity, the billing code ID 29 included in the billing code information 21, and a purchase code ID. The information on the purchased commodity includes the commodity ID and the purchase quantity of the commodity. Moreover, the information on the purchased commodity may include the price or the purchase price of the commodity. Moreover, the purchase information 22 may include the date and time of creation of the billing code information and the upper limit of billing.

### [Member Information Management Table]

FIG. 4 is a view illustrating the structure of the member information management table 23. The member information management table 23 is provided with the member information 25 corresponding to each of a plurality of members. In each piece of member information 25, the member ID is associated with a password for authentication, the name and address of the member and the like. Moreover, the member information 25 includes information necessary for commodity purchase. For example, it includes information related to the payment method and the upper limit of billing.

### [Purchaser Information Management Table]

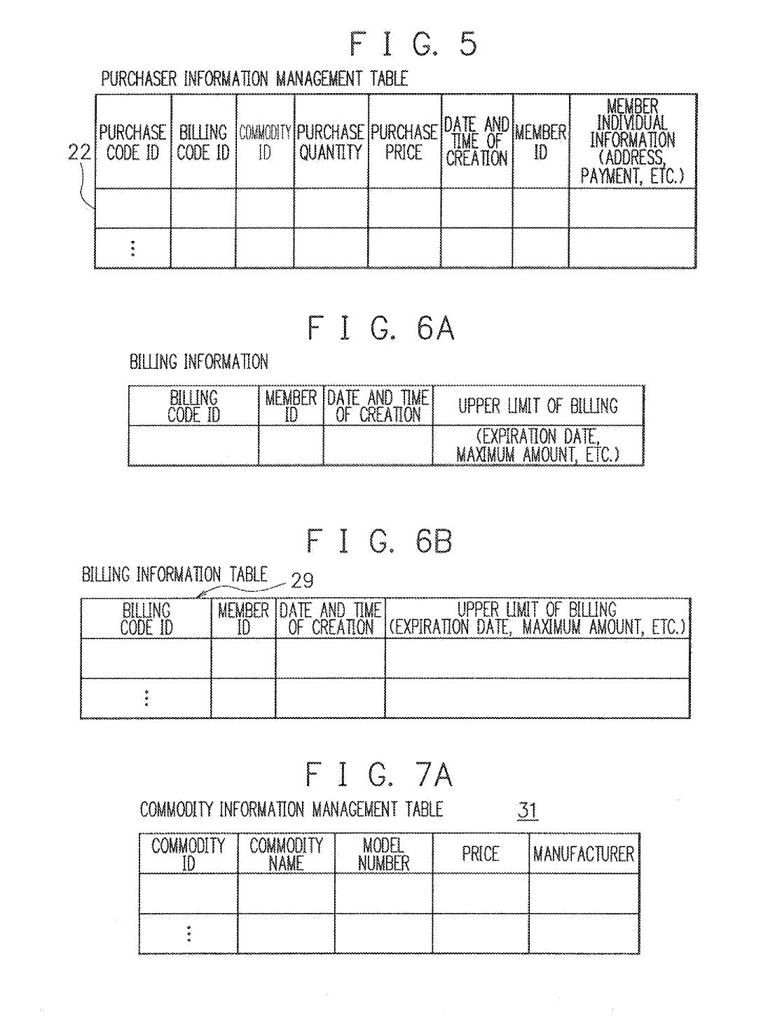

FIG. 5 is a view illustrating the structure of the purchaser information management table 24. The purchaser information management table 24 is provided with a plurality of pieces of purchase information 22. Each of the pieces of purchase information 22 is held in the purchaser information management table 24 in a state where the commodity ID, the purchase price, the purchase quantity, the billing code ID and the member ID and the date and time of creation are associated with one another. Moreover, the purchase information 22 may include the upper limit of billing.

### [Billing Information]

FIG. 6A is a view illustrating the structure of the billing information. In the billing information, information related to the date and time of creation of the billing information and the upper limit of billing are associated with the member ID. Moreover, the billing code ID to identify the billing information is associated with each piece of billing information. FIG. 6B is a view illustrating the structure of the billing information table. As shown in FIG. 6B, the billing information table is provided with a plurality of pieces of billing information.

### [Commodity Information Table]

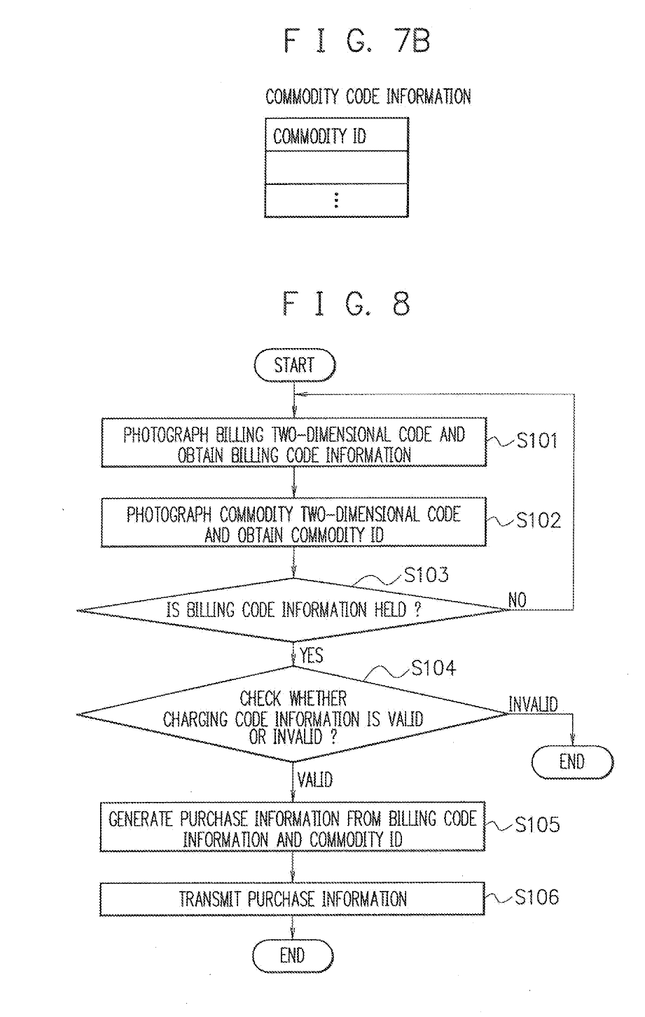

FIG. 7A is a view illustrating the structure of a commodity information table 31. FIG. 7B is a view illustrating the structure of the commodity code information. The commodity information table 31 includes a plurality of pieces of commodity information 32. Each of the pieces of commodity information 32 is held in the commodity information table 31 in a state where information such as the commodity name, the model number, the price and the manufacturer is associated with the commodity ID. The commodity information management server 5 holds at least the commodity ID as the commodity code information.

### [Operation of the Portable Terminal (Commodity Purchase)]

FIG. 8 is a flowchart illustrating the operation of the commodity purchase in the merchandise sales system 1 of the present embodiment.

### (1) Step S101

The user photographs the billing two-dimensional code 41 displayed on the user terminal apparatus 6 by using the camera 11 of the portable terminal 2. The decoder 12 of the portable terminal 2 decodes the photographed billing two-dimensional code 41, and obtains the billing code information 21.

### (2) Step S102

The user activates an application program for commodity purchase provided for the merchandise sales system 1 by using the portable terminal 2. Then, the user photographs the commodity two-dimensional code 42 according to the procedure shown by the application program. The decoder 12 of the portable terminal 2 decodes the commodity two-dimensional code 42 of the commodity into commodity code information, and obtains the commodity ID from the information included in the commodity code information.

### (3) Step S103

The portable terminal 2 executes a determination as to whether the billing code information 21 is stored in the billing code information holder 13 or not. When the billing code information 21 is stored as a result of the determination, the process proceeds to step S104, and when it is not stored, the process returns to step S101. At this time, a message prompting the user to perform the operation of step S101 may be displayed on the portable terminal.

### (4) Step S104

A determination as to whether the billing code information 21 is valid or invalid for the commodity to be purchased is executed. For example, by using the commodity ID (for example, the URL of the page introducing information on the commodity), connection is made to the commodity information management server 5 through a network and the price corresponding to the commodity ID of the commodity to be purchased is obtained, or by the price included in the commodity code information, when the price is higher than the upper limit of billing (the maximum amount) included in the billing code information, when the upper limit of billing (the expiration date) included in the billing code information is exceeded or when the upper limit of billing (the number of times of use) included in the billing code information is exceeded, it is determined that the billing code information is invalid, and the process ends. When the billing code information is valid, the process proceeds to step S105.

### (5) Step S105

When the purchase quantity of the commodity of the commodity code information is inputted according to the application program for commodity purchase, the price of the commodity (obtained from the commodity information management server 5 as described above, or included in the commodity code information) and the purchase quantity are multiplied by each other, the purchase price is displayed, and purchase intension is confirmed. When the user decides to purchase, the purchase information generator 14 generates the purchase information 22 including the billing code ID included in the billing code information, the commodity ID and the purchase quantity. In doing this, the purchase price may be included in the purchase information. When the commodity ID and the billing code ID are URLs, part identifying the commodity is cut out from the URL of the commodity ID and added to the URL of the billing code ID to create the URL of the purchase information.

### (6) Step S106

The purchase information transmitter 15 transmits the purchase information 22 to the member information management server 3.

### [Operation of the Member Information Management Server (Obtaining of the Purchase Information)]

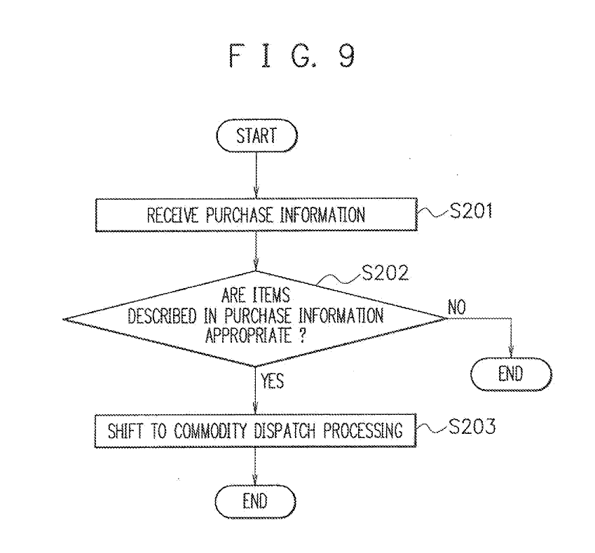

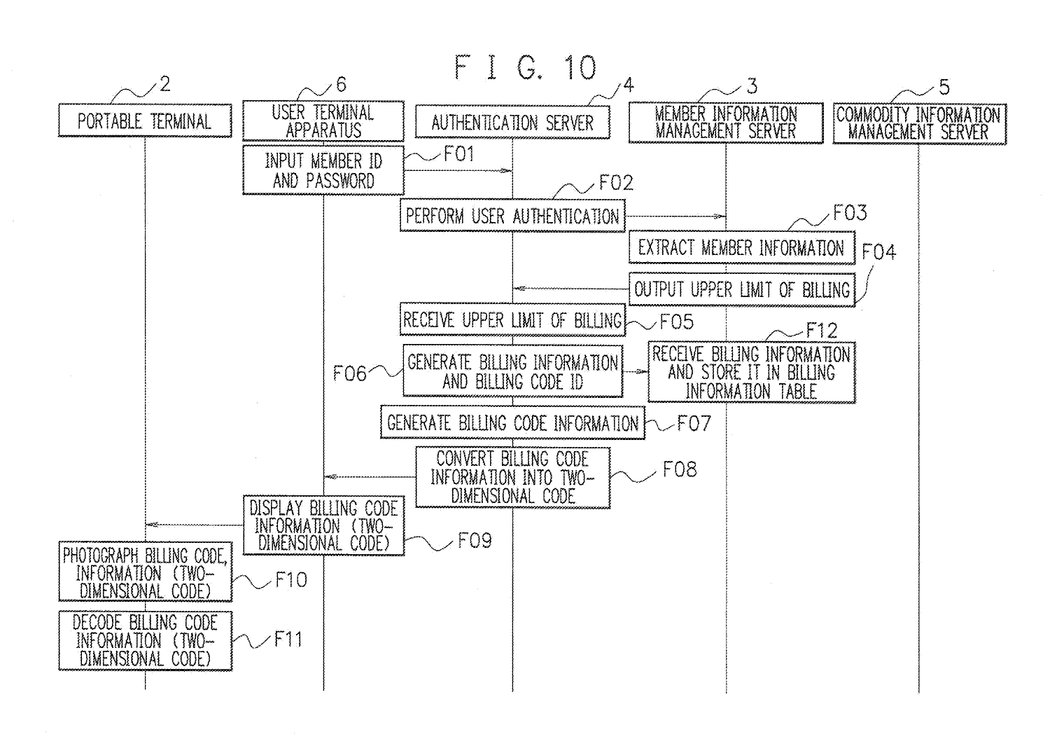

FIG. 9 is a flowchart illustrating the operation of the member information management server 3 having received the purchase information 22 supplied from the portable terminal 2.

### (1) Step S201

The member information management server 3 receives the purchase information 22 supplied through a network.

### (2) Step S202

A determiner of the member information management server executes a determination as to whether the information described in the purchase information 22 is appropriate or not. For example, when the purchase price included in the purchase information is higher than the maximum amount of the upper limit of billing stored in the billing information table corresponding to the purchase code ID included in the purchase information, when the date and time of creation of the purchase information or the date and time of reception of the purchase information is past the expiration date of the upper limit of billing of the billing information table or when the number of times of use of the upper limit of billing stored in the billing information table corresponding to the purchase code ID included in the purchase information is exceeded, it is determined that the information is inappropriate. When inappropriate information is included as a result of the determination, the process ends. When it is determined that the information of the purchase information 22 is appropriate as a result of the determination by the determiner, the process proceeds to step S203.

### (3) Step S203

The member information management server 3 executes, for the purchase of the commodity corresponding to the commodity ID included in the purchase information 22, the processing such as payment based on the payment method corresponding to the billing code ID and commodity dispatch to the member ID corresponding to the billing code ID. Moreover, the billing information stored in the authentication server is invalidated, the balance of the member information management table corresponding to the member ID is reduced by the amount corresponding to the purchase price (calculated by requesting the information on the price of the commodity associated with the commodity ID from the commodity information management server and multiplying the user-specified purchase quantity by the price, or included in the purchase information), or the number of times of use of the upper limit of billing is reduced. As an example of the commodity dispatch processing, for example, a dispatch processing instruction for dispatching the commodity identified by the commodity ID in the quantity to the address (refer to the member information) of the member ID identified by the billing code information is transmitted to the commodity information management server 5. As the dispatch processing, a member processing server may directly perform the arrangement of commodity dispatch without transmitting the dispatch instruction to the commodity information management server 5.

### [Operation of the Authentication Server (Generation of the Billing Code Information)]

FIG. 10 is a sequence diagram illustrating the operation of generating the billing code information 21 of the present embodiment. In the merchandise sales system 1 of the present embodiment, for example, the billing code information 21 is generated by operating according to the application program for generating the billing code information 21 which application program is provided in the user terminal apparatus 6.

### (1) Step F01

The user inputs the member ID and the password to the authentication server 4 by using the input unit 34 or the like of the user terminal apparatus 6.

### (2) Step F02

The user authentication executor 26 of the authentication server 4 executes user authentication by using the inputted member ID and password.

### (3) Step F03

The authentication server 4 extracts the member information 25 of the member ID the user authentication of which has been completed, from the member information management table 23 of the member information management server 3.

### (4) Step F04

It is requested to output information related to billing such as the items of the upper limit of billing (an item of the payment method may be included) from the member information 25.

### (5) Step F05

The authentication server 4 receives the information related to billing such as the upper limit of billing supplied from the member information management server 3.

### (6) Step F06

The billing code information generator 27 of the authentication server 4 generates billing information including the member ID and the upper limit of billing. The billing information may include the payment method and the like. The billing code information generator 27 transmits the billing information to the member information management server. The member information management server receives the billing information, and stores it in the billing information table (F12). At the same time, the authentication server 4 creates the billing code ID which is information to identify the billing information (for example, a combination of the member ID and the date and time of creation or a unique string using letters, numerals and symbols), and stores it in a storage as the billing code information so as to be associated with the billing information. The billing code ID may be the URL of the Web page for checking the billing information, and the billing information may be transmitted from this Web page to the terminal. When the billing code ID is a combination of the member ID and the date of creation, the member ID and the date of creation may be omitted in the billing information of the billing code information.

### (7) Step F07

Billing code information including the generated billing code ID and billing information is generated.

### (8) Step F08

Billing code information including the generated billing code ID and the upper limit of billing is generated. The billing code information may include the member ID.

### (9) Step F09

The display 33 of the user terminal apparatus 6 displays the billing code information converted into a two-dimensional code.

### (10) Step F10

The user photographs the displayed billing two-dimensional code 41 by using the camera 11 of the portable terminal 2.

### (11) Step F11

The decoder 12 of the portable terminal 2 decodes the photographed billing two-dimensional code 41, obtains the billing code information, and stores it in the billing code information holder 13. The billing code information may be encrypted data. In this case, a structure is preferable in which the billing code information is decoded by an application in the terminal and captured.

### [Operation of the Member Information Management Server (Generation of the Member Information Management Table)]

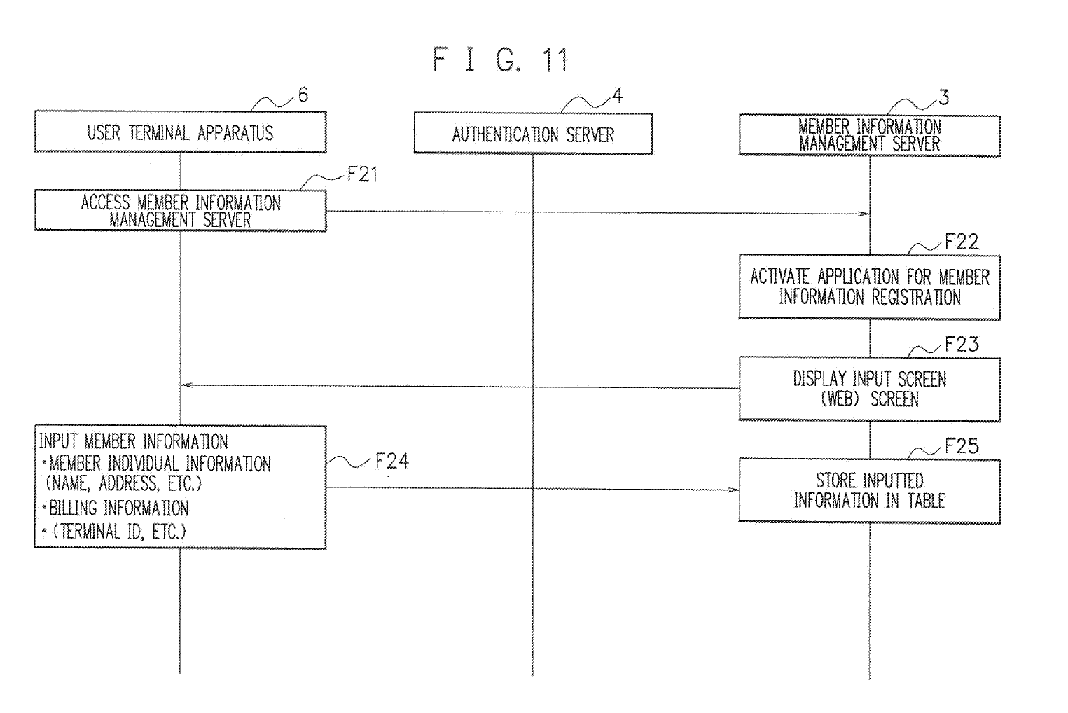

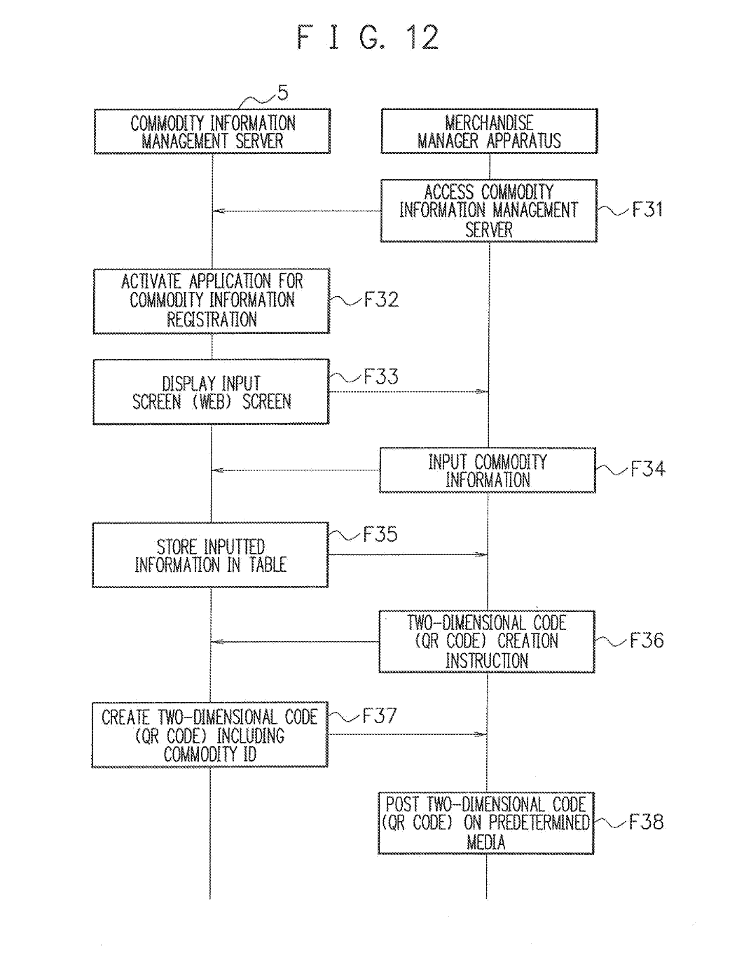

FIG. 11 is a sequence diagram illustrating the operation of registering the member information 25 in the member information management table 23. In the present embodiment, in order for the user to purchase a commodity, it is preferable that his/her member information be (previously) registered on the member information management server in advance. It is necessary that the member information management server 3 hold information necessary for billing (the member ID to identify the user, the password, the payment method and the upper limit of billing) as the contents of the user's own member information. Individual information such as the name and the address may be included depending on the intended use.

### (1) Step F21

The user accesses the member information management server 3 through the user terminal apparatus 6.

### (2) Step F22

A controller of the member information management server 3 activates an application program for member information registration in response to an instruction supplied from the user terminal apparatus 6.

### (3) Step F23

The member information management server 3 displays a member information input screen on the user terminal apparatus 6 by using a Web or the like according to the procedure shown by the application program.

### (4) Step F24

The user inputs member individual information such as the name and the address by using the input screen displayed on the user terminal apparatus 6. Moreover, the user inputs billing information (information such as the upper limit of billing). Moreover, specifications may be adopted where the ID or the like of the portable terminal 2 is registered.

### (5) Step F25

The member information management server 3 writes the inputted information in the member information management table 23 to update the contents. After the registration, a member ID and a password may be assigned to the member as a proof of being a member.

### [Operation of the Commodity Information Management Server (Generation of the Two-Dimensional Code)]

FIG. 12 is a sequence diagram illustrating the operation of generating a two-dimensional code of the commodity to be sold. By a user (hereinafter, referred to as a merchandise manager) merchandise manager apparatus, the commodity information of each commodity is pre-registered in the merchandise management server. For this registration, a scheme is used where a work screen for the merchandise manager is displayed on a Web or the like by the controller of the commodity information management server calling the manager apparatus. The inputted commodity information is stored in a storage of the merchandise management server.

### (1) Step F31

The commodity information management server 5 is accessed through the merchandise manager apparatus.

### (2) Step F32

The commodity information management server 5 activates an application program for commodity information registration in response to an instruction from the merchandise manager apparatus.

### (3) Step F33

The commodity information management server 5 displays a commodity information input screen on the merchandise manager apparatus according to the procedure shown by the application program.

### (4) Step F34

The merchandise manager inputs commodity information such as the commodity name and price by using the input screen displayed on the merchandise manager apparatus.

### (5) Step F35

The commodity information management server 5 writes the inputted commodity information in the commodity information table 31 to update the contents. In doing that, the commodity ID to identify the commodity information is generated and stored in the commodity information table 31 so as to be associated with the commodity information.

### (6) Step F36

A two-dimensional code creation instruction is supplied to the commodity information management server 5 through the merchandise manager apparatus.

### (7) Step F37

In response to the instruction, the commodity information management server 5 generates commodity code information including the commodity ID, and converts the commodity code information into a two-dimensional code to create the commodity two-dimensional code 41. In doing that, the commodity code information may include commodity information such as the commodity name and price. The commodity ID may be the URL of the Web page to check the commodity information, and the commodity information may be transmitted from this Web page to the terminal when the user selects a commodity. The commodity information management server 5 supplies the data of the created two-dimensional code including the commodity ID to the merchandise manager apparatus. The merchandise manager posts the two-dimensional code including the commodity ID on predetermined media (media such as an EC site of the commodity, an electronic advertisement, a signboard and a television, and paper media including the two-dimensional code).

As described above, in the merchandise sales system 1 of the present embodiment, there is no need to manually input information related to billing by using a touch panel or a portable terminal keyboard when a commodity is purchased by using the portable terminal 2. As described above, the customer (previously) incorporates the billing code information into the mobile terminal (portable terminal 2) with a home PC (user terminal apparatus 6) or the like in advance, the commodity code information can be captured into the mobile terminal from a street advertisement or the like, and information to confirm the commodity purchase can be created by using the above-described billing code information and commodity code information. For the customers' part, it is possible to purchase a commodity anytime and anywhere by (previously) holding in the mobile terminal the billing information necessary for commodity purchase in advance.

### Second Embodiment

Hereinafter, a second embodiment of the invention of the present application will be described with reference to the drawings.

### [Operation of the Portable Terminal]

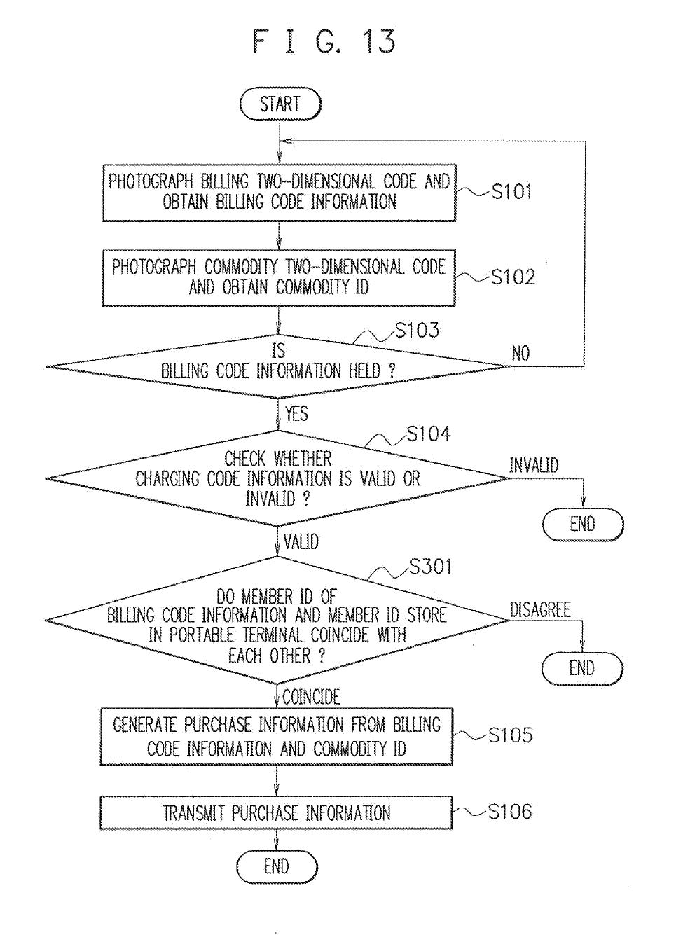

FIG. 13 is a flowchart illustrating the operation of the portable terminal 2 in the merchandise sales system 1 of the second embodiment. The flowchart of FIG. 13 illustrates the operation of the portable terminal 2 which is different from the operation illustrated in FIG. 8. Moreover, in the merchandise sales system 1 of the second embodiment, the member ID is previously held in the portable terminal 2. Moreover, the billing code information 21 of the second embodiment includes the billing code ID 29, the upper limit of billing and the member ID.

Referring to FIG. 13, from step S101 to step S104, processing is performed similarly to the operation of the flowchart of FIG. 8. In the second embodiment, when it is determined that the billing code information is valid as a result of the determination of step S104, the process proceeds to step S301.

### (1) Step S301

The member ID of the billing code information and the member ID held in the portable terminal 2 are collated with each other. When they disagree with each other as a result of the collation, the process ends. When the member IDs of these coincide with each other, the process proceeds to step S105. Thereafter, processing is performed similarly to the operation of the flowchart of FIG. 8.

In the merchandise sales system 1 of the second embodiment, the controller of the portable terminal 2 checks whether the member ID in the billing code information and the member ID stored in the storage of the portable terminal 2 match with each other or not. By doing this, a problem can be suppressed in that erroneous purchase information is created.

### Third Embodiment

Hereinafter, a third embodiment of the invention of the present application will be described with reference to the drawings.

### [Operation of the Portable Terminal]

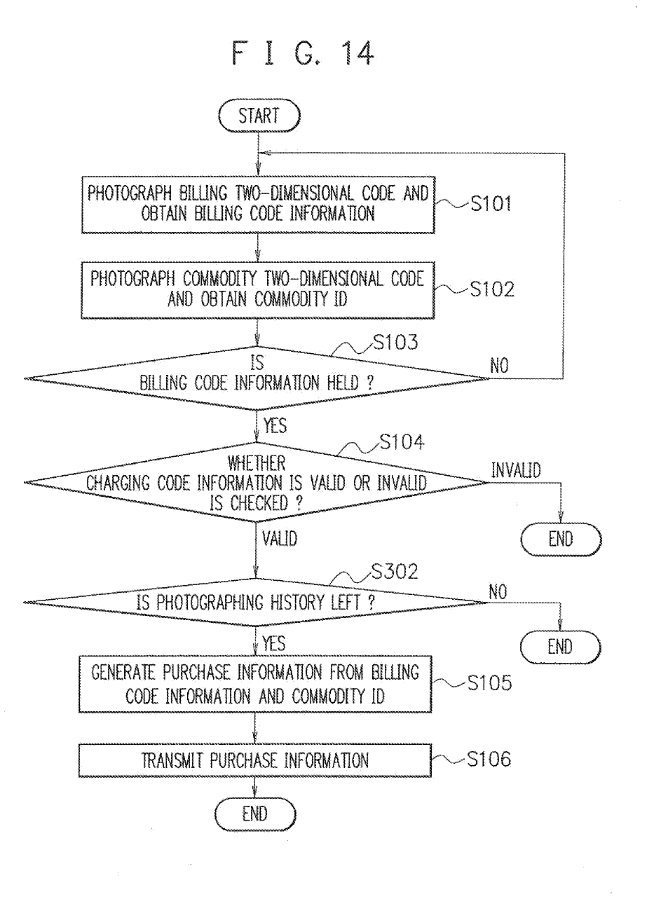

FIG. 14 is a flowchart illustrating the operation of the portable terminal 2 in the merchandise sales system 1 of the third embodiment. The flowchart of FIG. 14 illustrates the operation of the portable terminal 2 which is different from the operation illustrated in FIG. 8 and FIG. 13. Moreover, in the merchandise sales system 1 of the third embodiment, the portable terminal 2 is provided with the function of storing the history of photographing by the camera 11.

### (1) Step S101

The user photographs the billing two-dimensional code 41 displayed on the user terminal apparatus 6 by using the camera 11 of the portable terminal 2. When the billing two-dimensional code is photographed, the portable terminal 2 stores the date and time of photographing and a photographing history to the effect that the billing two-dimensional code is photographed. Thereafter, from step S102 to S104, processing is performed similarly to the operation of the flowchart of FIG. 8. In the third embodiment, when it is determined that the billing code information is valid as a result of the determination of step S104, the process proceeds to step S302.

### (1) Step S302

A determination as to whether the photographing history of photographing the billing two-dimensional code is stored or not is executed. When no photographing history is left as a result of the determination, the process ends. When the photographing history is left, the process proceeds to step S105. Thereafter, processing is performed similarly to the operation of the flowchart of FIG. 8.

In the merchandise sales system 1 of the third embodiment, when the portable terminal 2 obtains the commodity ID and the billing code information from the two-dimensional code, the history of the camera use date and time information of the terminal or the like is recorded as a proof of being obtained from the two-dimensional code by the portable terminal 2 with a camera or the like. By doing this, a problem can be suppressed in that erroneous purchase information is created.

### Fourth Embodiment

Hereinafter, a fourth embodiment of the invention of the present application will be described with reference to the drawings.

The merchandise sales system 1 of the fourth embodiment is provided with information related to the balance when a product was purchased before. Moreover, the member information management server 3 of the fourth embodiment has the function of obtaining information related to by whom and when the billing information was created, from the created billing code information and associating it with the member ID to manage the balance.

### [Member Information Management Table]

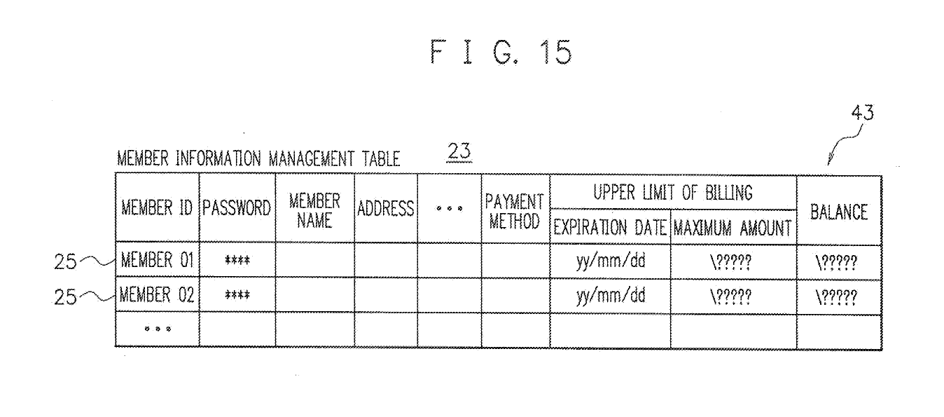

FIG. 15 is a view illustrating the structure of the member information management table 23 of the fourth embodiment. As shown in FIG. 15, the member information management table 23 of the fourth embodiment includes the balance 43.

### [Operation of the Merchandise Sales System]

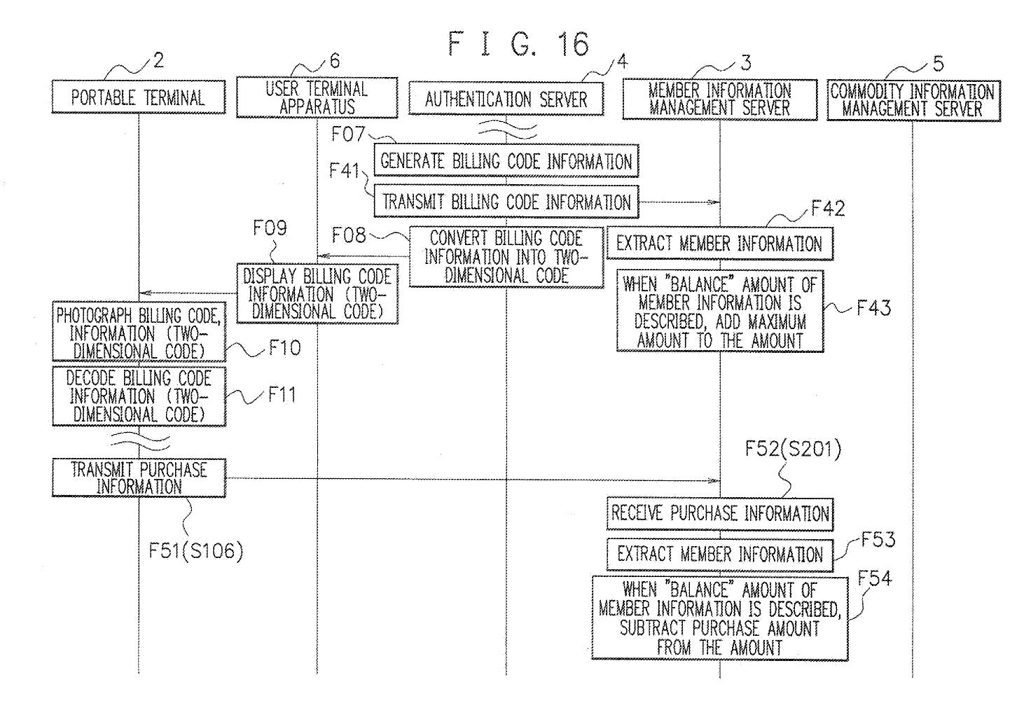

FIG. 16 is a sequence diagram illustrating the operation of the fourth embodiment. As shown in FIG. 16, in the merchandise sales system 1 of the fourth embodiment, after the processing of step F07 is performed, the processing of step F41 is executed before the processing of step F08 is performed.

### (1) Step F41

The authentication server 4 generates billing information including the member ID, and supplies the billing information to the member information management server 3.

### (2) Step F42

The member information management server 3 extracts the member information corresponding to the member ID included in the received billing information.

### (3) Step F43

When the amount is described in the balance 43 of the extracted member information, to the amount, the maximum amount included in the billing information is added to update the member information management table 23.

### (4) Step F51

Thereafter, when the user decides to purchase the commodity to be purchased, the purchase information is transmitted from the portable terminal 2 to the member information management server 3.

### (5) Step F52

The member information management server 3 receives the transmitted purchase information.

### (6) Step F53

Based on the member ID included in the purchase information, the corresponding member information is extracted.

### (7) Step F54

When the amount is described in the balance 43 of the member information, from the amount, the purchase amount is subtracted to update the member information management table 23. When the balance is updated, the amount of the updated balance may be transmitted to the portable terminal.

Embodiments of the invention of the present application have concretely been described above. The invention of the present application is not limited to the above-described embodiments but may be modified variously without departing from the gist thereof. For example, while a case where the object to be sold is a commodity is shown as an example, the commodity is not limited to an article but includes service. Moreover, the above-described embodiments may be carried out in combination as long as no contradiction arises in the structure and the operation.

### Examples of the Hardware

Hereinafter, concrete examples of the hardware for implementing the merchandise sales system 1 according to the present invention will be described.

As examples of the portable terminal 2, a portable telephone, a smartphone, a smartbook, a car navigation system, a portable game apparatus, a portable music player, a handy terminal and a gadget (electronic apparatus) are considered. Moreover, the portable terminal 2 may be mounted on a mobile object such as a vehicle, a ship or an aircraft.

As examples of the member information management server 3, the authentication server 4 and the commodity information management server 5, computing machines such as a PC (personal computer), an appliance, a thin-client server, a workstation, a mainframe and a super computer are assumed. In actuality, they are not limited to a terminal or a server, and may be a relay apparatus or a peripheral apparatus. Moreover, they may be an extension board mounted on a computing machine or the like or a virtual machine (VM) constructed on a physical machine.

As examples of the user terminal apparatus 6, the following are considered: computing machines such as a PC (personal computer), an IP telephone machine, a home video game machine, an interactive television, a digital tuner, a digital recorder, an information home appliance, an OA (office automation) apparatus, a point-of-sales terminal and sophisticated copier, and a digital signage.

As examples of the two-dimensional code display medium 7, display devices such as a television screen and paper media such as a magazine are assumed. Moreover, examples of the two-dimensional code display medium 7 may be similar to the above-mentioned examples of the portable terminal 2.

Although not shown, it is considered that the apparatuses and machines as described above are implemented by a processor driven based on a program and executing predetermined processing, a memory storing the program and various pieces of data and an interface used for communication with a network.

As examples of the above-mentioned processor, a CPU (central processing unit), a network processor (NP), a microprocessor, a microcontroller and a semiconductor integrated circuit (LSI: large scale integration) having an exclusive function are considered.

As examples of the above-mentioned memory, the following are considered: semiconductor storage devices such as a RAM (random access memory), a ROM (read only memory), an EEPROM (electrically erasable and programmable read only memory) and a flash memory, auxiliary storage devices such as an HDD (hard disk drive) and an SSD (solid state drive), removable disks such as a DVD (digital versatile disk), and storage media such as an SD memory card (secure digital memory card). Moreover, it may be a buffer, a register or the like. Alternatively, it may be a storage device using a DAS (direct attached storage), an FC-SAN (fibre channel-storage area network), an NAS (network attached storage), an IP-SAN (IP-storage area network) or the like.

The above-mentioned processor and the above-mentioned memory may be integrated. For example, in recent years, more and more microcomputers and the like have been formed on one chip. Therefore, a case is considered where a one-chip microcomputer mounted on an electronic device or the like is provided with the above-mentioned processor and the above-mentioned memory.

As examples of the above-mentioned interface, semiconductor integrated circuits such as a board (a motherboard, an I/O board) and a chip capable of network communication, network adaptors such as an NIC (network interface card) and similar extension cards, communication devices such as an antenna, and communication ports such as a connector.

Moreover, as examples of the network, the following are considered: the Internet, a LAN (local area network), a wireless LAN, a WAN (wide area network), a backbone, a cable television (CATV) line, a land-line telephone network, a portable telephone network, WiMAX (IEEE 802.16a), 3G (3rd generation), a lease line, IrDA (infrared data association), Bluetooth (trademark), a serial communication line and a data bus.

The elements in the portable terminal 2, the member information management server 3, the authentication server 4, the commodity information management server 5 and the user terminal apparatus 6 may be modules, components, dedicated devices, or boot (calling) programs therefor.

However, in actuality, the present invention is not limited to these examples.

This application is based upon and claims the benefit of priority from Japanese patent application No. 2012-081124, the disclosure of which is incorporated herein its entirety by reference.

1. A merchandise sales system comprising:
an authentication server that generates billing code information related to billing referred to when a commodity is purchased;
a portable terminal capable of reading a two-dimensional code; and
a member information management server that manages preregistered information related to a member,
wherein the authentication server
generates billing information including an upper limit of billing indicative of a purchasable range when a commodity is purchased and a billing code ID for identifying the billing information,
transmits the billing code ID and the billing information to the member information management server,
generates the billing code information including the billing code ID and the upper limit of billing, and
generates a billing two-dimensional code from the billing code information,
the portable terminal
reads the billing two-dimensional code and obtains the billing code information,
reads a commodity two-dimensional code generated from commodity code information including a commodity ID to identify information on a commodity to be purchased and obtains the commodity code information,
when purchase of the commodity corresponding to the commodity ID is within the upper limit of billing included in the billing code information, generates purchase information including the commodity ID included in the commodity code information and the billing code ID included in the billing code information, and
transmits the purchase information to the member information management server through a network, and
the member information management server
holds the billing code ID and the billing information so as to be associated with each other,
receives the purchase information through the network, and
for the purchase of the commodity corresponding to the commodity ID included in the purchase information, confirms payment based on the billing information corresponding to the billing code ID included in the purchase information.

2. The merchandise sales system according to claim 1,
wherein the portable terminal
obtains a price identified by the commodity ID of the commodity to be purchased, or calculates a purchase price from the price and a quantity of the commodity to be purchased, by using the price of the commodity included in the commodity code information,
compares the purchase price with the upper limit of billing included in the billing code information,
determines whether purchase is possible or not, and
when purchase is possible, generates the purchase information.

3. The merchandise sales system according to claim 2,
wherein the portable terminal
generates the purchase information including also the purchase price, and
the member information management server
compares the purchase price included in the purchase information with the upper limit of billing of the billing information, and determines whether purchase is possible or not.

4. The merchandise sales system according to claim 3, further comprising a commodity information management server that manages information on a commodity to be sold,
wherein the commodity information management server generates the commodity two-dimensional code, and provides the generated commodity two-dimensional code to a medium that is readable by the portable terminal.

5. The merchandise sales system according to claim 1,
wherein the authentication server
generates the billing code information including the member ID, and
the portable terminal
previously holds the member ID,
determines whether the member ID included in the billing code information obtained by reading the billing two-dimensional code and the previously held member ID coincide with each other, and
when the member IDs coincide with each other, generates the purchase information.

6. The merchandise sales system according to claim 1,
wherein the portable terminal
holds a history when the billing two-dimensional code is read,
determines whether the history is held or not when the purchase information is generated, and
generates the purchase information when the history is held.

7. The merchandise sales system according to claim 1, wherein the authentication server generates the billing information including also a payment method, and the member information management server confirms purchase of the commodity by the payment method of the billing information corresponding to the billing code ID included in the purchase information.

8. The merchandise sales system according to claim 1,
wherein the member information management server
adds the upper limit of billing included in the billing information to a balance and holds it when the billing code ID and the billing information are received, and
subtracts the purchase price from the balance after purchase of the commodity.

9. A merchandise sales system server capable of information communication with a portable terminal capable of reading a two-dimensional code, comprising:
an authenticator that generates billing code information related to billing referred to when a commodity is purchased; and
a member information manager that manages preregistered information related to a member,
herein the authenticator
generates billing information including an upper limit of billing indicative of a purchasable range when a commodity is purchased and a billing code ID for identifying the billing information,
transmits the billing code ID and the billing information to the member information management server,
generates the billing code information including the billing code ID and the upper limit of billing, and
generates a billing two-dimensional code from the billing code information, and
when from the portable terminal having obtained the billing code information and commodity code information, purchase information including the commodity ID included in the commodity code information and the billing code ID included in the billing code information is transmitted to the member information manager through a network,
the member information manager
holds the billing code ID and the billing information so as to be associated with each other,
receives the purchase information through the network, and
for the purchase of the commodity corresponding to the commodity ID included in the purchase information,
confirms payment based on the billing information corresponding to the billing code ID included in the purchase information.

10. A portable terminal applicable to a merchandise sales system that sells a commodity through a network, and capable of reading a two-dimensional code, the portable terminal
reading a billing two-dimensional code including a billing code ID for identifying billing information including an upper limit of billing indicative of a purchasable range when a commodity is purchased, and obtaining billing code information included in the billing two-dimensional code,
reading a commodity two-dimensional code generated from commodity code information including a commodity ID to identify information on a commodity to be purchased, and obtaining the commodity code information included in the commodity two-dimensional code,
when purchase of the commodity corresponding to the commodity ID is within the upper limit of billing included in the billing code information, generating purchase information including the commodity ID included in the commodity code information and the billing code ID included in the billing code information, and
transmitting the purchase information through a network to the member information management server that manages preregistered information related to a member.

11. The portable terminal according to claim 10,
wherein the portable terminal
obtains a price identified by the commodity ID of the commodity to be purchased, or calculates a purchase price from the price and the quantity of the commodity to be purchased, by using the price of the commodity included in the commodity code information,
compares the purchase price with the upper limit of billing included in the billing code information,
determines whether purchase is possible or not, and
when purchase is possible, generates the purchase information.

12. The portable terminal according to claim 11,
wherein a member ID for identifying an owner of the portable terminal is held previously, and
when the billing two-dimensional code is read and the member ID included in the billing code information is obtained, a determination as to whether the obtained member ID and the previously held member ID coincide with each other or not is executed, and when the two member IDs coincide with each other, the purchase information is generated.

13. The portable terminal according to claim 12,
herein a history as to whether the billing two-dimensional code has been read or not is held, and
when the purchase information in which the commodity ID indicated by the commodity two-dimensional code and the billing code information are associated with each other is generated, a determination as to whether the history is held or not is executed, and when the history is held, the purchase information is generated.

14. A storage medium storing a merchandise sales system server program showing a procedure for causing a computer to function as a merchandise sales system server capable of information communication with a portable terminal capable of reading a two-dimensional code, the storage medium storing the merchandise sales system server program showing the procedure for causing the computer to function as the merchandise sale system server by causing the computer to execute
(a) a step of generating billing code information related to billing referred to when a commodity is purchased, and
(b) a step of managing preregistered information related to a member,
wherein the step (a) includes:
a step of generating billing information including an upper limit of billing indicative of a purchasable range when a commodity is purchased and a billing code ID for identifying the billing information;
a step of transmitting the billing code ID and the billing information to the member information manager;
a step of generating the billing code information including the billing code ID and the upper limit of billing; and
a step of generating a billing two-dimensional code from the billing code information, and
when from the portable terminal having obtained the billing code information and commodity code information, purchase information including the commodity ID included in the commodity code information and the billing code ID included in the billing code information is transmitted to the member information manager through a network,
the step (b) includes:
a step of holding the billing code ID and the billing information so as to be associated with each other;
a step of receiving the purchase information through the network; and
a step of, for the purchase of the commodity corresponding to the commodity ID included in the purchase information, confirming payment based on the billing information corresponding to the billing code ID included in the purchase information.

15. An operation method of a merchandise sales system provided with: an authentication server that generates billing code information related to billing referred to when a commodity is purchased; a portable terminal capable of reading a two-dimensional code; and a member information management server that manages preregistered information related to a member,
wherein the authentication server
generates billing information including an upper limit of billing indicative of a purchasable range when a commodity is purchased and a billing code ID for identifying the billing information,
transmits the billing code ID and the billing information to the member information management server,
generates the billing code information including the billing code ID and the upper limit of billing, and
generates a billing two-dimensional code from the billing code information,
the portable terminal
reads the billing two-dimensional code and obtains the billing code information,
reads a commodity two-dimensional code generated from commodity code information including a commodity ID to identify information on a commodity to be purchased and obtains the commodity code information,
when purchase of the commodity corresponding to the commodity ID is within the upper limit of billing included in the billing code information, generates purchase information including the commodity ID included in the commodity code information and the billing code ID included in the billing code information, and transmits the purchase information to the member information management server through a network, and
the member information management server
holds the billing code ID and the billing information so as to be associated with each other,
receives the purchase information through the network, and
for the purchase of the commodity corresponding to the commodity ID included in the purchase information, confirms payment based on the billing information corresponding to the billing code ID included in the purchase information.

16. The merchandise sales system according claim 2,
wherein the authentication server
generates the billing code information including the member ID, and
the portable terminal
previously holds the member ID,
determines whether the member ID included in the billing code information obtained by reading the billing two-dimensional code and the previously held member ID coincide with each other, and
when the member IDs coincide with each other, generates the purchase information.

17. The merchandise sales system according claim 3,
wherein the authentication server
generates the billing code information including the member ID, and
the portable terminal
previously holds the member ID,
determines whether the member ID included in the billing code information obtained by reading the billing two-dimensional code and the previously held member ID coincide with each other, and
when the member IDs coincide with each other, generates the purchase information.

18. The merchandise sales system according claim 4,
wherein the authentication server
generates the billing code information including the member ID, and
the portable terminal
previously holds the member ID,
determines whether the member ID included in the billing code information obtained by reading the billing two-dimensional code and the previously held member ID coincide with each other, and
when the member IDs coincide with each other, generates the purchase information.

19. The merchandise sales system according to claim 2,
wherein the portable terminal
holds a history when the billing two-dimensional code is read,
determines whether the history is held or not when the purchase information is generated, and
generates the purchase information when the history is held.

20. The merchandise sales system according to claim 3,
wherein the portable terminal
holds a history when the billing two-dimensional code is read,
determines whether the history is held or not when the purchase information is generated, and
generates the purchase information when the history is held.

21. The merchandise sales system according to claim 4,
wherein the portable terminal
holds a history when the billing two-dimensional code is read,
determines whether the history is held or not when the purchase information is generated, and
generates the purchase information when the history is held.

22. The merchandise sales system according to claim 5,
wherein the portable terminal
holds a history when the billing two-dimensional code is read,
determines whether the history is held or not when the purchase information is generated, and
generates the purchase information when the history is held.

23. The merchandise sales system according to claim 2, wherein the authentication server generates the billing information including also a payment method, and the member information management server confirms purchase of the commodity by the payment method of the billing information corresponding to the billing code ID included in the purchase information.

24. The merchandise sales system according to claim 3, wherein the authentication server generates the billing information including also a payment method, and the member information management server confirms purchase of the commodity by the payment method of the billing information corresponding to the billing code ID included in the purchase information.

25. The merchandise sales system according to claim 4, wherein the authentication server generates the billing information including also a payment method, and the member information management server confirms purchase of the commodity by the payment method of the billing information corresponding to the billing code ID included in the purchase information.

26. The merchandise sales system according to claim 5, wherein the authentication server generates the billing information including also a payment method, and the member information management server confirms purchase of the commodity by the payment method of the billing information corresponding to the billing code ID included in the purchase information.

27. The merchandise sales system according to claim 6, wherein the authentication server generates the billing information including also a payment method, and the member information management server confirms purchase of the commodity by the payment method of the billing information corresponding to the billing code ID included in the purchase information.

28. The merchandise sales system according to claim 2,
wherein the member information management server
adds the upper limit of billing included in the billing information to a balance and holds it when the billing code ID and the billing information are received, and
subtracts the purchase price from the balance after purchase of the commodity.

29. The merchandise sales system according to claim 3,
wherein the member information management server
adds the upper limit of billing included in the billing information to a balance and holds it when the billing code ID and the billing information are received, and
subtracts the purchase price from the balance after purchase of the commodity.

30. The merchandise sales system according to claim 4,
wherein the member information management server
adds the upper limit of billing included in the billing information to a balance and holds it when the billing code ID and the billing information are received, and
subtracts the purchase price from the balance after purchase of the commodity.

31. The merchandise sales system according to claim 5,
wherein the member information management server
adds the upper limit of billing included in the billing information to a balance and holds it when the billing code ID and the billing information are received, and
subtracts the purchase price from the balance after purchase of the commodity.

32. The merchandise sales system according to claim 6,
wherein the member information management server
adds the upper limit of billing included in the billing information to a balance and holds it when the billing code ID and the billing information are received, and
subtracts the purchase price from the balance after purchase of the commodity.

33. The merchandise sales system according to claim 7,
wherein the member information management server
adds the upper limit of billing included in the billing information to a balance and holds it when the billing code ID and the billing information are received, and
subtracts the purchase price from the balance after purchase of the commodity.
